(19) United States
(12) Patent Application Publication
(10) Pub. No.: US 2022/0083736 A1
(43) Pub. Date: Mar. 17, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yumi SEKIGUCHI, Kanagawa (JP)

(73) Assignee: FUJIFILM Business Innovation Corp., Tokyo (JP)

(21) Appl. No.: 17/225,124

(22) Filed: Apr. 8, 2021

(30) Foreign Application Priority Data
Sep. 17, 2020 (JP) 2020-156360

(51) Int. Cl. G06F 40/268; G06N 5/02; G06F 40/30; G06F 16/904

(52) U.S. Cl. CPC G06F 40/268; G06F 16/904; G06F 40/30; G06N 5/02

(57) ABSTRACT

An information processing apparatus includes a processor configured to: acquire a content serving as a search target and character string data related to the content; extract multiple words from the character string data in accordance with results of morphological analysis performed on the acquired character string data; construct a word knowledge base that associates a word of interest of the extracted words with information indicating a nodal relationship between the word of interest of the extracted words serving as a node and each remaining word of the extracted words serving as a node and having a semantic distance shorter than a predetermined distance; and construct a combined knowledge base that associates with the information indicating the nodal relationship a degree of importance of each of the words present on the word knowledge base from among the words in the content.

### CROSS-REFERENCE TO RELATED APPLICATIONS

This application is based on and claims priority under 35 USC 119 from Japanese Patent Application No. 2020-156360 filed Sep. 17, 2020.

### BACKGROUND

### (i) Technical Field

The present disclosure relates to an information processing apparatus and a non-transitory computer readable medium.

### (ii) Related Art

A variety of techniques are available to search a vast amount of data for target document data of a user. For example, Japanese Unexamined Patent Application Publication No. 2001-331515 discloses a technique of constructing a thesaurus by clustering words on document data based on natural language. The disclosed technique includes a clustering operation, a disambiguation operation, a re-clustering operation, and a thesaurus production operation. The clustering operation determines a semantic distance between words in accordance with a co-occurrence relationship of the words and classifies words having a shorter distance into the same class. The disambiguation operation determines ambiguity on a per word basis in accordance with the clustering results, recognizes a word having ambiguity as two or more different words, and corrects the co-occurrence relationship in accordance with the recognition. The re-clustering operation performs the clustering operation again in accordance with co-occurrence relationship data that is corrected in the disambiguation operation. The thesaurus operation constructs a thesaurus based on the re-clustering operation.

Techniques are available to visualize document data in graphics to understand the meaning of the document data. For example, Japanese Unexamined Patent Application Publication No. 2020-024698 discloses a technique of producing a knowledge graph. The disclosed technique includes an operation of constructing a graph database in accordance with an entity set in a specific content and an entity relationship, an operation of receiving a graph entry for the specific content from a user, and an operation of producing a knowledge graph for the specific content by using a format layout predefined based on the graph database. The knowledge graph has a network structure. The knowledge graph for the specific content is automatically constructed based on the produced graph database.

Semantic search is used to search for a content, such as a sentence or document. The semantic search outputs search results, based on semantic information of an input character string. The semantic search, however, performs a search operation by using not only information directly described in the content as a search target but also information related to the meaning of a sentence or word in the content, such as a knowledge base that expresses a connection of meta information in the form of data. The knowledge base is manually constructed in view of the content. The production of the knowledge base is thus time-consuming.

### SUMMARY

Aspects of non-limiting embodiments of the present disclosure relate to providing an information processing apparatus and non-transitory computer readable medium reducing a processing load, such as processing time, involved in constructing a knowledge base in comparison with when a knowledge base is manually constructed each time a content as a search target is acquired.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a content serving as a search target and character string data related to the content; extract multiple words from the character string data in accordance with results of morphological analysis performed on the acquired character string data; construct a word knowledge base that associates a word of interest of the extracted words with information indicating a nodal relationship between the word of interest of the extracted words serving as a node and each remaining word of the extracted words serving as a node and having a semantic distance shorter than a predetermined distance; and construct a combined knowledge base that associates with the information indicating the nodal relationship a degree of importance of each of the words present on the word knowledge base from among the words in the content.

### BRIEF DESCRIPTION OF THE DRAWINGS

Exemplary embodiments of the present disclosure will be described in detail based on the following figures, wherein:

FIG. 1 illustrates a configuration of an example of a network system in accordance with an exemplary embodiment;

FIG. 2 is an electrical block diagram of an example of an information processing apparatus in accordance with the exemplary embodiment;

FIG. 3 is a functional block diagram of an example of the information processing apparatus in accordance with the exemplary embodiment;

FIG. 4 illustrates an example of content data out of input data in accordance with the exemplary embodiment;

FIG. 5 illustrates an example of dictionary data out of the input data in accordance with the exemplary embodiment;

FIG. 6 illustrates an example of analysis results of an analyzing unit in accordance with the exemplary embodiment;

FIG. 7 illustrates an example of community data in accordance with the exemplary embodiment;

FIG. 8 illustrates an example of a word group on each classified community in accordance with the exemplary embodiment;

FIG. 9 illustrates a semantic distance of the exemplary embodiment;

FIG. 10 illustrates a word knowledge base of the exemplary embodiment;

FIG. 11 illustrates a concept of the word knowledge base;

FIG. 12 illustrates information related to extracting a word in a calculation function of a combining unit in accordance with the exemplary embodiment;

FIG. 13 illustrates a combined knowledge base in accordance with the exemplary embodiment;

FIG. 14 is a flowchart illustrating a process of an information processing program of the exemplary embodiment;

FIG. 15 is a flowchart illustrating a process of the information processing program of the exemplary embodiment;

FIG. 16 illustrates the word knowledge base of the exemplary embodiment; and

FIG. 17 illustrates the word knowledge base of the exemplary embodiment.

### DETAILED DESCRIPTION

Exemplary embodiments that embody a technique of the disclosure are described below with reference to the drawings. Elements and processes responsible for the same operation and function are designated with the same reference numeral and the description thereof is not duplicated. Each drawing is detailed enough to roughly understand the exemplary embodiments. The technique of the disclosure is not limited to examples in the drawings. Configuration not directly linked with the disclosure and configuration in the related art may not necessarily be described.

The term “semantic distance” is a concept of a search process in which target document data of a user is searched from a vast amount data in accordance with information indicating the meaning of an input character string.

The semantic search is used to search for a content, such as a sentence or document. The semantic search outputs search results, based on semantic information of an input character string. The semantic search, however, performs a search operation by using not only information directly described in the content as a search target but also information related to the meaning of the sentence or word in the content, such as a knowledge base that expresses a connection of meta data in the form of data. The knowledge base is manually constructed in view of the content. The production of the knowledge base is thus time-consuming.

In exemplary embodiments, the content as a search target and character string data related to the content are obtained. A word in the character string data is extracted in accordance with results of the morphological analysis of the character string data. A word knowledge base is constructed. The word knowledge base associates each of the extracted words with information indicating a nodal relationship between each of the extracted words as a node and another word of the extracted words as a node having a semantic distance shorter than a predetermined distance. A combined knowledge base is then constructed. The combined knowledge base associates a degree of importance of each of the words present on the word knowledge base from among the words in the acquired content with the information indicating the nodal relationship.

### First Exemplary Embodiment

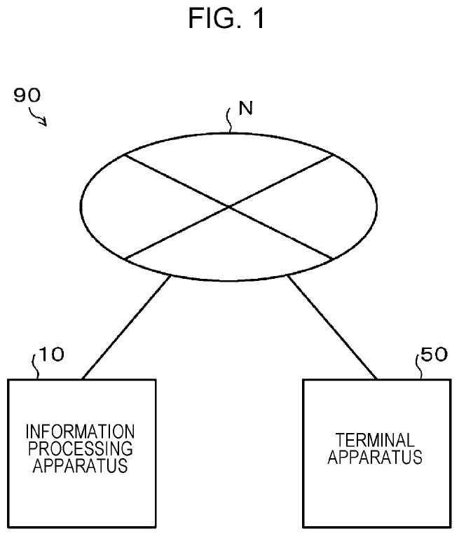

FIG. 1 illustrates a configuration of a network system 90 of a first exemplary embodiment that embodies the technique of the disclosure.

Referring to FIG. 1, the network system 90 includes an information processing apparatus 10 and terminal apparatus 50. The information processing apparatus 10 of the first exemplary embodiment is a general-purpose computer, such as a server computer or a personal computer (PC).

The information processing apparatus 10 of the first exemplary embodiment is connected to the terminal apparatus 50 via a network N. The network N may include a local-area network (LAN) and/or wide-area network (WAN). The terminal apparatus 50 may be a general-purpose computer, such as a PC, or a portable computer, such as a smart phone or tablet terminal. FIG. 1 illustrates a single terminal apparatus 50. The disclosure is not limited to the use of the single terminal apparatus 50 and may include two or more terminal apparatuses 50.

The information processing apparatus 10 of the first exemplary embodiment has a knowledge base production function that constructs a knowledge base to perform a semantic search operation in response to data input via the terminal apparatus 50.

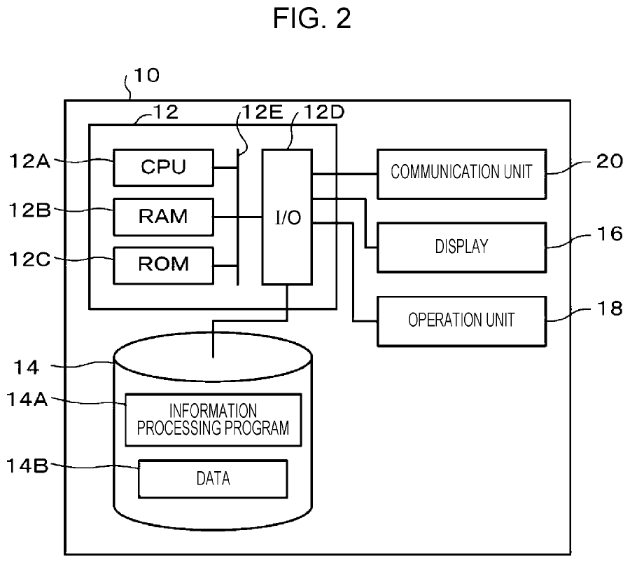

FIG. 2 is an electrical block diagram illustrating an example of the information processing apparatus 10 of the first exemplary embodiment.

Referring to FIG. 2, the information processing apparatus 10 includes a controller 12, memory 14, display 16, operation unit 18, and communication unit 20.

The controller 12 includes a central processing unit (CPU) 12A, random-access memory (RAM) 12B, read-only memory (ROM) 12C, and input-output (I/O) interface 12D. These elements are interconnected to each other via a bus 12E.

The I/O interface 12D connects to the memory 14, display 16, operation unit 18, and communication unit 20. These elements are interconnected to the CPU 12A for communication via the I/O interface 12D.

The controller 12 may be implemented as a second controller that controls part of the information processing apparatus 10 or as part of a first controller that controls the whole operation of the information processing apparatus 10. Part or whole of each block of the controller 12 may include an integrated circuit, such as a large-scale integration (LSI) chip, or an integrated circuit (IC) chip set. Each block may include an individual circuit or part or whole of the blocks may include an integrated circuit. The blocks may be integrated into a unitary body or some blocks may be separately arranged as a unitary body. Each of the blocks may be arranged as an external unit. The controller 12 may be integrated using a LSI chip, a dedicated circuit, or a versatile processor.

The memory 14 may include a hard disk drive (HDD), solid-state drive (SSD), or a flash memory. The memory 14 stores an information processing program 14A that implements an information processing process of the first exemplary embodiment. The CPU 12A executes the information processing program 14A by retrieving the information processing program 14A from the memory 14 and expanding the information processing program 14A on the RAM 12B. The information processing apparatus 10 executing the information processing program 14A operates as the information processing apparatus of the first exemplary embodiment. The information processing program 14A may be stored on the ROM 12C. The memory 14 also stores a variety of data 14B.

The information processing program 14A may be pre-installed on the information processing apparatus 10. The information processing program 14A may be distributed in a recorded form on a non-volatile recording medium or via the network N and then appropriately installed on the information processing apparatus 10. The non-volatile recording medium include a compact disc read-only memory (CD-ROM), magneto-optical disk, HDD, digital versatile disc read-only memory (DVD-ROM), flash memory, and memory card.

The display 16 includes, for example, a liquid-crystal display (LCD) or organic electroluminescent (EL) display. A touch panel may be integrated with the display 16. The operation unit 18 includes an operation input device, such as a keyboard and mouse. The display 16 and operation unit 18 receive a variety of instructions from a user of the information processing apparatus 10. The display 16 displays results of a process performed in response to an instruction from the user and a variety of information including a notice about the process.

The communication unit 20 is connected to the Internet and/or the network N, such as the LAN or WAN and communicates with the terminal apparatus 50 via the network N.

The semantic search performs a search operation by using not only information directly described in the content as a search target but also information related to the meaning of the sentence or word in the content, such as a knowledge base that expresses a connection of meta data in the form of data. The knowledge base is manually constructed in view of the content. The production of the knowledge base is thus time-consuming.

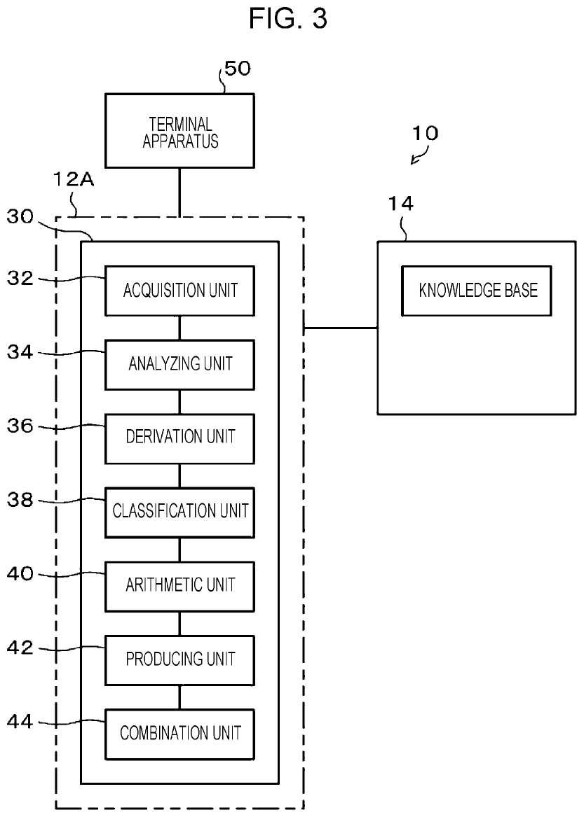

The CPU 12A in the information processing apparatus 10 of the first exemplary embodiment operates as the elements in FIG. 3 by writing the information processing program 14A from the memory 14 onto the RAM 12B and executing the information processing program 14A.

FIG. 3 is an example of a functional block diagram of the information processing apparatus 10.

Referring to FIG. 3, the CPU 12A in the information processing apparatus 10 of the first exemplary embodiment functions as a knowledge base generator 30. The knowledge base generator 30 includes an acquisition unit 32, analyzing unit 34, derivation unit 36, classification unit 38, arithmetic unit 40, producing unit 42, and combination unit 44.

A constructed knowledge base (described in detail below) is stored on the memory 14 of the first exemplary embodiment. The knowledge base is information related to sentences of a content and words of the content. Specifically, the knowledge base is data representing a connection of meta information. An example of the knowledge base is a set of information on related nodes that are connected by edges with the nodes represented by the meta information. The edge associates the related nodes from among multiple node representing concepts. The content includes a document, image (including a video), and/or sound.

The knowledge base is typically defined using web ontology language (OWL) in a semantic web. Conceptual information (also referred to as “class”) related to the knowledge base is formulated by resource description framework (RDF) on which OWL is based. The knowledge base may be a directed graph or an undirected graph. Each node is assigned with the conceptual information representing physical or virtual presence. The presence of things is expressed by connecting pieces of conceptual information with an edge having a label different from type of relation to type of relation of the pieces of conceptual information.

The knowledge base generator 30 constructs a knowledge base by using input data onto the terminal apparatus 50 used by a user.

The acquisition unit 32 acquires the input data on the terminal apparatus 50 used by the user. Examples of the input data are content data and character string data related to the content data.

According to the first exemplary embodiment, a document is acquired as the content data serving as a search target and dictionary data is acquired as the character string data.

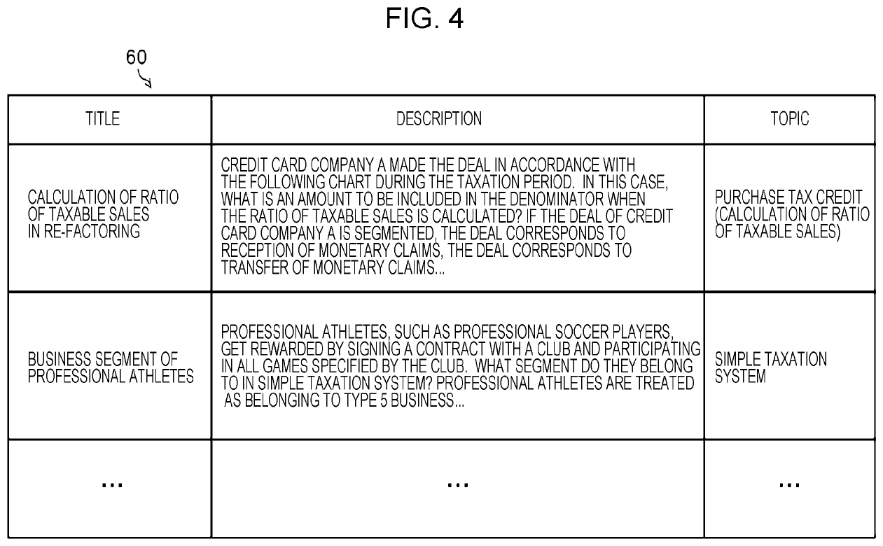

FIG. 4 illustrates an example of the content data out of the input data of the first exemplary embodiment. The example of the content data is an information group (such as text data) that is stored in accordance with a predetermined format.

FIG. 4 illustrates as the example of the content data a table 60 having a format that associates a title, description, and topic. A first record stores a title reading “Calculation of ratio taxable sales in re-factoring” at the title column. The first record stores at the description column a description reading “Credit card company A made the deal in accordance with the following chart during the taxation period. In this case, what is an amount to be included in the denominator when the ratio of taxable sales is calculated? If the deal of credit card company A is segmented, the deal corresponds to reception of monetary claims, the deal corresponds to transfer of monetary claims . . . ” The first record stores a topic reading “Purchase tax credit (calculation of ratio of taxable sales)” at the topic column.

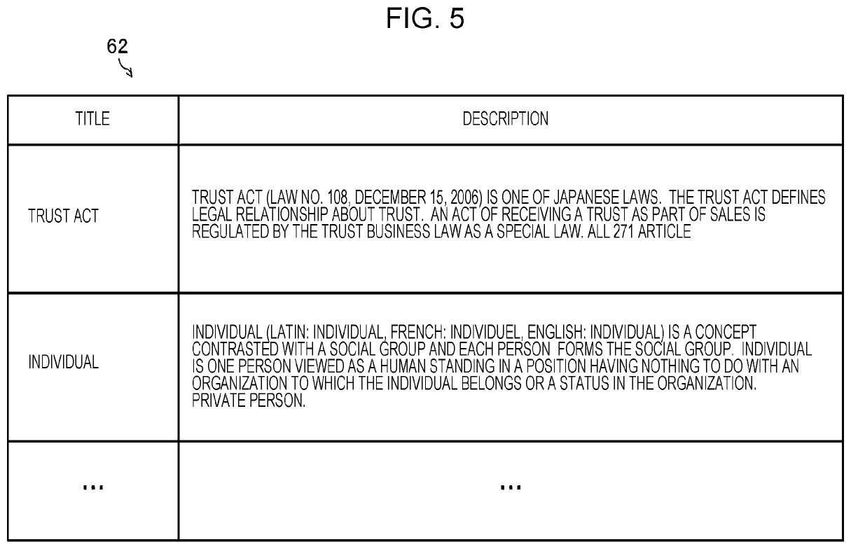

FIG. 5 illustrates an example of the dictionary data out of the input data of the first exemplary embodiment. The example of the dictionary data is a storage information group including information (such as text data) in a predetermined format.

FIG. 5 illustrates as the example of the dictionary data a table 62 that associates the title with the description. For example, the first record stores a title reading “Trust act” at the title column. Referring to FIG. 5, data of words is stored at the title column. Alternatively, a character string may be stored at the title column. The first record stores, at the description column, character string data reading “Trust act (Law No. 108, Dec. 15, 2006) is one of Japanese laws. The trust act defines legal relationship about trust. An act of receiving a trust as part of sales is regulated by the trust business law as a special law. All 271 article.”

The analyzing unit 34 morphologically analyzes acquired dictionary data and extracts a word as a noun from among the analysis results of the words. Specifically, the analyzing unit 34 segments the acquired dictionary data into a strain of words as morphemes and determines the part of speech of each word. The analyzing unit 34 extracts a noun out of the words. The technique of morphological analysis is a related-art technique and is not described in detail herein.

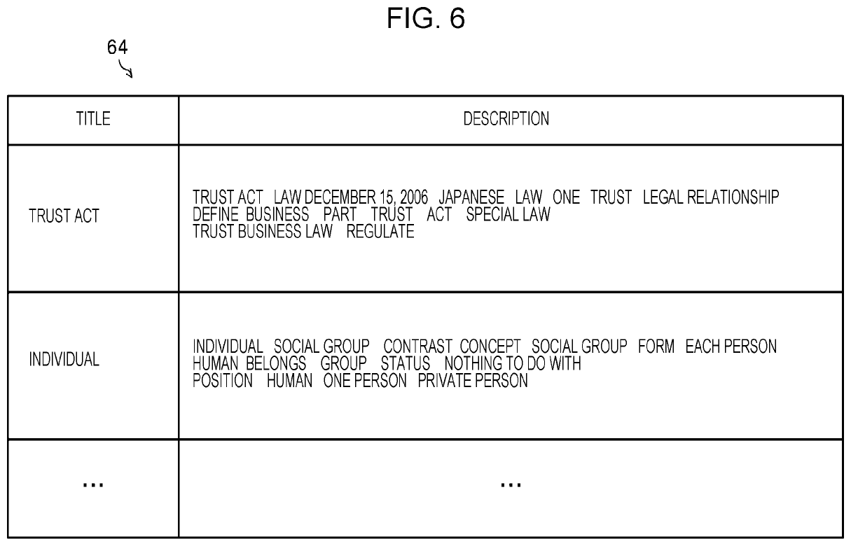

FIG. 6 illustrates an example of the analysis results of the analyzing unit 34 of the first exemplary embodiment. The analysis results indicate the information group including data corresponding to the dictionary data.

FIG. 6 illustrates as the example of the analysis results a table 64 that associates information as a title and description. For example, the first record stores word data “Trust act” at the title column. The first record also stores, at the description column, noun words “trust act, Law Dec. 15, 2006, Japanese, law, one, trust, legal relationship, define, business, part, trust, act, special law, trust business law, regulate.”

The derivation unit 36 derives community data of multiple words as nouns. The nouns may be understood as belonging to an aggregate of words having a relationship of a semantic distance shorter than a predetermined distance. Information body indicating the aggregate of words is a community and data on each word as a noun is derived as community data. Specifically, the community is the information body indicating a set of words having a semantic distance shorter than the predetermined distance. The community data includes data indicating a probability at which each of the words is present at each of the communities. According to the first exemplary embodiment, a technique of deriving the community data is a technique of modular decomposition of Markov chain (MDMC).

MDMC is the related-art technique and is thus not described in detail herein. MDMC is described in “Modular decomposition of Markov chain: detecting hierarchical organization of pervasive communities,” Hiroshi Okamoto, Xu-le Qiu arXiv: 1909. 07066v3 [physics. soc-ph] 6 Dec. 2019.

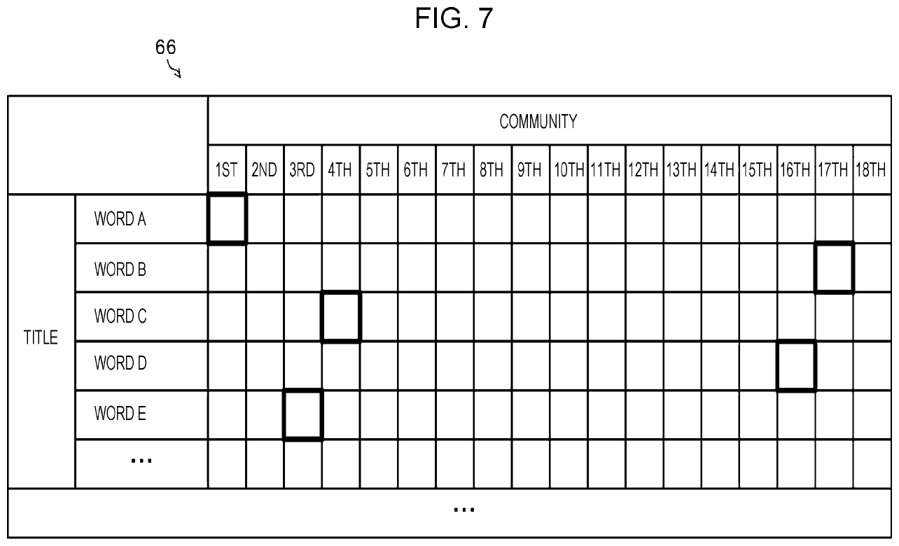

FIG. 7 illustrates an example of the community data derived via MDMC in accordance with the first exemplary embodiment.

FIG. 7 illustrates, as information including the derived community data, a table 66 that associates a word with the community data of each community corresponding to the word. In the analysis results in FIG. 7, 18 communities are created with respect to the dictionary data, the probability at which each of the noun words thus extracted is preset at each of multiple communities is derived as the community data and is then stored. Specifically, the community data of each of all noun words included in a single title, namely, the community data of each of all words starting with word A in FIG. 7, is derived through MDMC. Referring to FIG. 7, the words are denoted as word A, word B, . . . . For example, the analysis results in FIG. 6 may now be considered. Concerning “trust act” in the title column, the words “trust act” in the description column corresponds to the word A in FIG. 7, “law Dec. 15, 2006” corresponds to the word B, “Japanese” corresponds to the word C, “law” corresponds to the word D, and “one” corresponds to the word E.

Using the derived community data, the classification unit 38 classifies each of the noun words into one of the communities in accordance with a classification condition.

An example of the classification condition is to indicate that the value of probability as the community data of the word belongs to a community having a predetermined value or higher. In this case, the classification condition may be to indicate that the value of the probability as the community data belongs a community having a maximum value.

MDMC outputs a probability distribution (namely, multiple pieces of community data) at which each of the noun words is present at each of the communities. For this reason, the probability at which the word is present at the community represented by the community data is higher as the value of the community data of the word increases. The community having the community data of the word, namely, the value of the probability being the predetermined value or higher or being the maximum value is set to be the community to which the word belongs. Words with the value of the probability having the predetermined value or higher or the maximum value may thus congregate at the community.

According to the first exemplary embodiment, the classification condition of the words is the community with the value of the probability having the maximum value as the community data of the word and each word is classified into one of the communities. Referring to FIG. 7, a location where the value of the probability as the community data of the word is maximized is denoted by a thick-bordered box. For example, the word A is maximized at the first community and thus classified into the first community. The word B is maximized at the 17th community and thus classified into the 17th community.

According the technique of the disclosure, each word may be classified into not only a single community but also multiple communities.

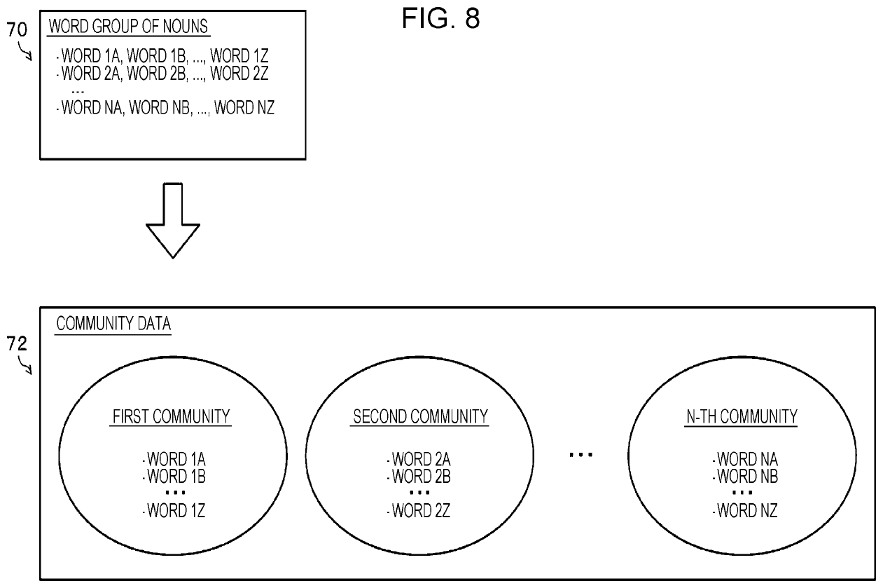

FIG. 8 illustrates an example of a word group on each community into which words are classified by the classification unit 38 of the first exemplary embodiment.

Referring to FIG. 8, the noun word group as classification targets is denoted by a block 70. The noun word group classified is represented as information having the community data by a block 72 that is a set of belonging words on a per community basis.

In the block 70 in FIG. 8, multiple words classified in the first community are denoted by word 1A through word 1Z. Multiple words classified in the second community are denoted by word 2A through word 2Z. Multiple words classified in the N-th community are denoted by word NA through word NZ. The words in FIG. 7 are differently denoted from the words in FIG. 8. For example, the word A in FIG. 7 is classified in the first community and thus denoted by word 1A in FIG. 8.

Each of the communities to which the classified words belong may be regarded as an information body that is a set of mutually related noun words. Each of words belonging to the same community serves as a word node including meta information. The word nodes may be candidates that are connected by an edge.

The arithmetic unit 40 calculates a distance between multiple words belonging to the same community. The words belonging to the same community are mutually related to each other but a relationship between words may be varied in intensity. The arithmetic unit 40 thus identifies the relationship among the words by calculating the semantic distance between the words.

The relationship between the words belonging to the same community varies depending on the semantic distance of the words. Specifically, among the words belonging to the same community, the relationship between a first word and a second word different from the first word increases in intensity as the semantic distance between the first word and the second word decreases. For example, the second word having the semantic distance equal to or shorter than a predetermined distance to the first word has a stronger relationship than a third word having the semantic distance longer than the predetermined distance to the first word. The second word having the minimum semantic distance to the first word has the strongest relationship among the words belonging to the same community. In this way, the relationship among the noun words present at the same community is identified based on the distance of the words belonging to the same community. The semantic distance may be calculated using information, such as Kullback-Leibler divergence indicating a difference between two probability distributions. Also, the semantic distance may also be calculated using data (the value of probability) derived through MDMC.

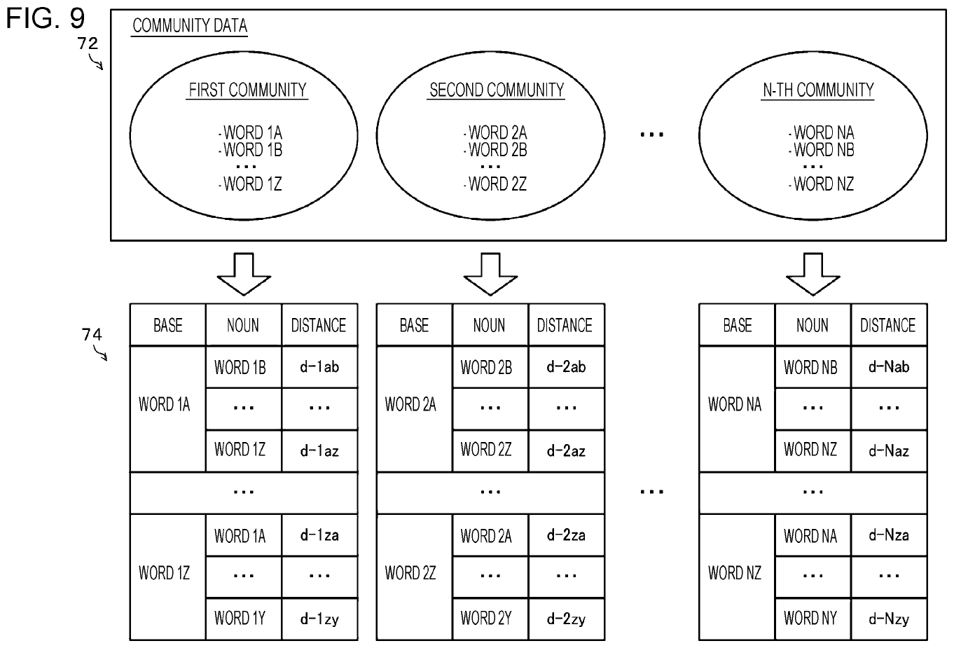

FIG. 9 illustrates the semantic distance calculated by the arithmetic unit 40 of the first exemplary embodiment. FIG. 9 illustrates, on a per community basis of the block 72, information including the semantic distance calculated between the words.

Referring to FIG. 9, the semantic distance between one word and another of the words belonging to the same community is calculated on a per community basis. Specifically, the semantic distance of one of the words 1A through 1Z to each of the others at the first community is calculated. FIG. 9 illustrates the semantic distances determined through the calculation in a table 74 that associates a “base,” “noun,” and “distance” as information on each community including the information on the semantic distances between the words. The base is information on a first word and the noun is information on a second word. The distance is information on the semantic distance between the first word and second word. For example, the semantic distance of the word 1A to the word 1B is d-lab. Similarly, the semantic distance of each of the words in the second community through N-th community is calculated.

The producing unit 42 constructs a word knowledge base in accordance with the calculated semantic distance. Specifically, the relationship among the words in the community is identified in accordance with a predetermined distance condition. The producing unit 42 then constructs the word knowledge base in accordance with the identified the relationship between the words.

One example of the distance condition indicates that a set of a first word and second word having a semantic distance equal to or shorter than a predetermined value is extracted. Another example of the distance condition indicates that the number of word sets to be extracted is a predetermined number. In this case, a distance difference between the minimum semantic distance and the maximum semantic distance is set to be adjustable in a manner such that a predetermined number of word sets is obtained.

The word set is extracted using the semantic distance in accordance with the distance condition. The relationship among the words in the community is thus identified.

The word knowledge base is constructed based on the identified relationship among the words.

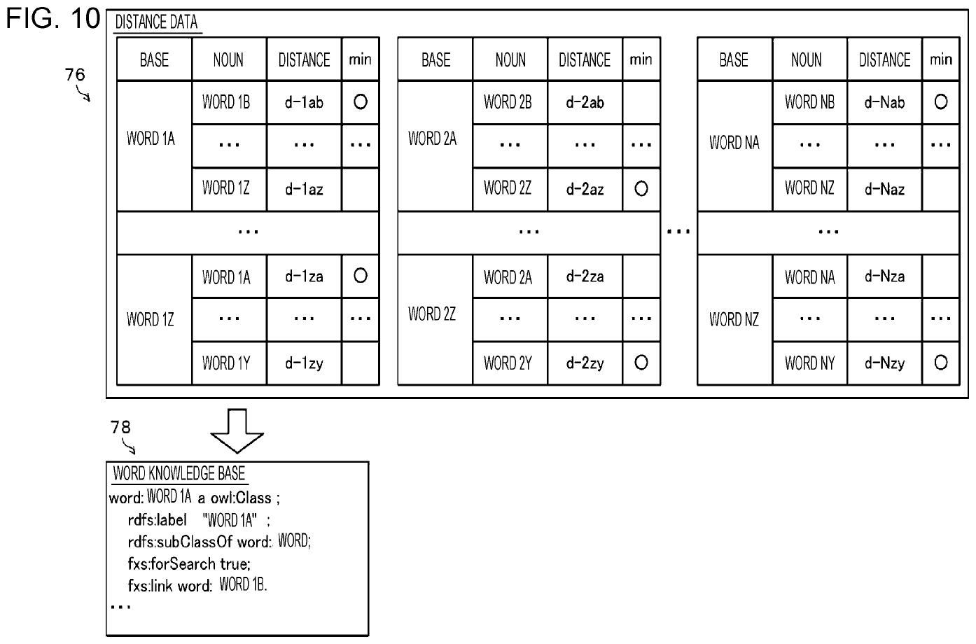

FIG. 10 illustrates the word knowledge base constructed by the producing unit 42 of the first exemplary embodiment.

Referring to FIG. 10, an example of distance data is information including the semantic distance and an example of the word knowledge base is constructed using the distance data.

Referring to FIG. 10, a table 76 indicates the distance data and associates a “base,” “noun,” “distance,” and “min” on each community. The information denoted by min indicates one word to which another word at the same community has a minimum distance. Specifically, in the table 76 in FIG. 10, the second word as the noun has a minimum semantic distance to the first word at the base and is associated with identification information (represented by a circle in FIG. 10). A block 78 indicating the relationship on each word is the word knowledge base constructed based on the distance data.

The producing unit 42 constructs the word knowledge base by extracting a predetermined number of words in accordance with the distance condition (a noun having a minimum semantic distance) with respect to each noun and associating the extracted words, namely, the word sets.

According to the first exemplary embodiment, the word knowledge base is expressed in resource description framework (RDF). For example, assuming that the second word having a minimum distance to the first word may now has a relationship, the relationship may be established by connecting the first word and second word with an edge (making a link between the first word and second word). This operation is expressed as below.
word: word 1A fxs: link word: word 1B

The relationship of the word set of word 1A and word 1B is expressed as below.

word: word 1A a owl: Class;

rdfs: label “word 1A”;
rdfs: subClassOf word: word;
fxs: forSearch true;
fxs: link word: word 1B

The producing unit 42 associates the word sets, namely, producing information indicating the edge (link) between word nodes, on all words (nouns). The word knowledge base is thus constructed by writing information indicating the relationship among produced word nodes.

Referring to FIG. 10, the word knowledge base includes word nodes respectively for words 1A through NZ. For example, a word node “word: word 1A a owl: Class” is described as a word node for the word 1A. One or more labels are imparted to each of the word nodes. “rdsfs: label” is imparted to the word node having the label. One or more types of the relationship are defined between the word nodes and any word having no relationship defined for is not linked. If word nodes are related in a superordinate to subordinate concept, “subClassof” is imparted between the word nodes. To indicate a word as a search target, “fxs: forSearch” is imparted to the word. Referring to FIG. 10, “true” indicating a value serving as the search target is described. Also, a word node label “fxs: link” is imparted to the relationship between the word nodes as a word set. Referring to FIG. 10, “word 1B” indicating a link destination is described.

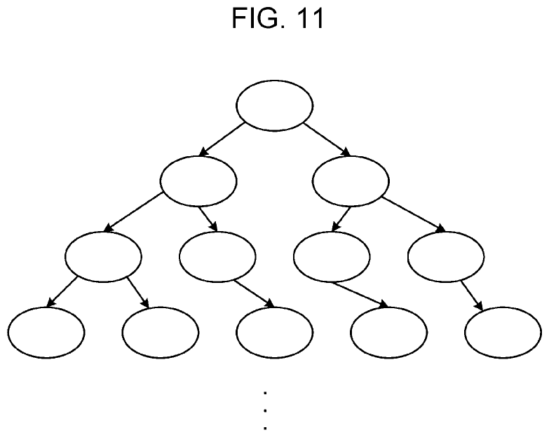

FIG. 11 is a conceptual chart of the word knowledge base of the first exemplary embodiment. Oval shapes in FIG. 11 represent word nodes.

Referring to FIG. 11, the word knowledge base expressing the relationship between word nodes is constructed in a structure in which word nodes respectively representing nouns are linked by edges.

The combination unit 44 constructs a combined knowledge base by combining the word knowledge base and an input content. The combination unit 44 has a calculation function of calculating the degree of importance of the content of a word and a combination creation function of producing the combined knowledge base by combining the content, the degree of importance, and the word knowledge base.

In the calculation function, the combination unit 44 extracts a word included in the word knowledge base from the character string data of the content and calculates the degree of importance of the word node indicating a feature of the content of the extracted word.

The degree of importance of the word node is calculated through term frequency (TF)-inverse document frequency (IDF) technique. TF represents an appearance frequency of a word and IDF represents an inverse document frequency. The degree of importance is represented by a value (tfidf value) as a product of TF and IDF (TF*IDF). TF is higher as the appearance frequency of a specific word in a given document is higher and IDF is lower as a word appearing in other documents appears more frequently. TF*IDF thus serves as an index indicating a word characteristic of the content (for example, a document).

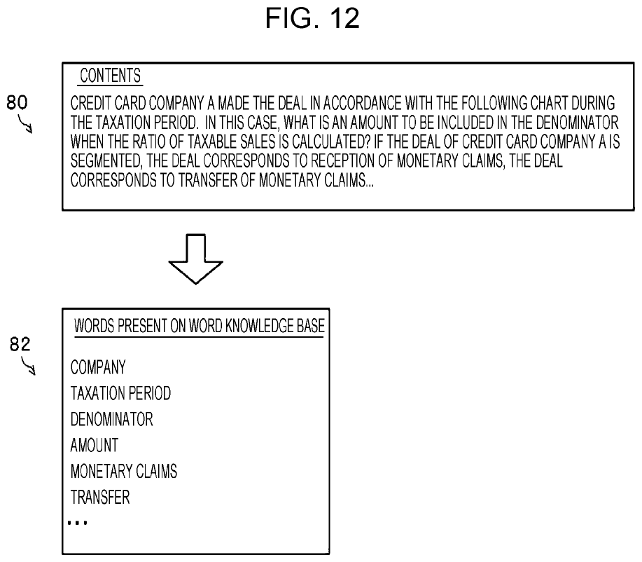

FIG. 12 illustrates information related to extracting a word through the calculation function of the combination unit 44 of the first exemplary embodiment.

Referring to FIG. 12, a block 80 represents an input content. A block 82 represents a word group of words included in the word knowledge base extracted from the character string data of the content. Referring to FIG. 12, the words included in the word knowledge base extracted from the character string data of the input content are “company,” “taxation period,” “denominator,” “amount,” “monetary claims,” “transfer,” . . . . The degree of importance of each extracted word is calculated and associated with the word node.

In the combination creation function, the combination unit 44 constructs a combined knowledge base that associates and combines the content, degree of importance, and word knowledge base. Specifically, the combined knowledge base is constructed by associating a content node with a word node.

The content node is information including character string data indicated in the content and includes information to which the degree of importance of a word in the character string data indicated in the content is added. The word node is information related to the character string data indicated in the content. The word node includes information related to the character string data indicated in the content and includes information where the word of a second word node associated with a first word node as a word indicated by the word node is described.

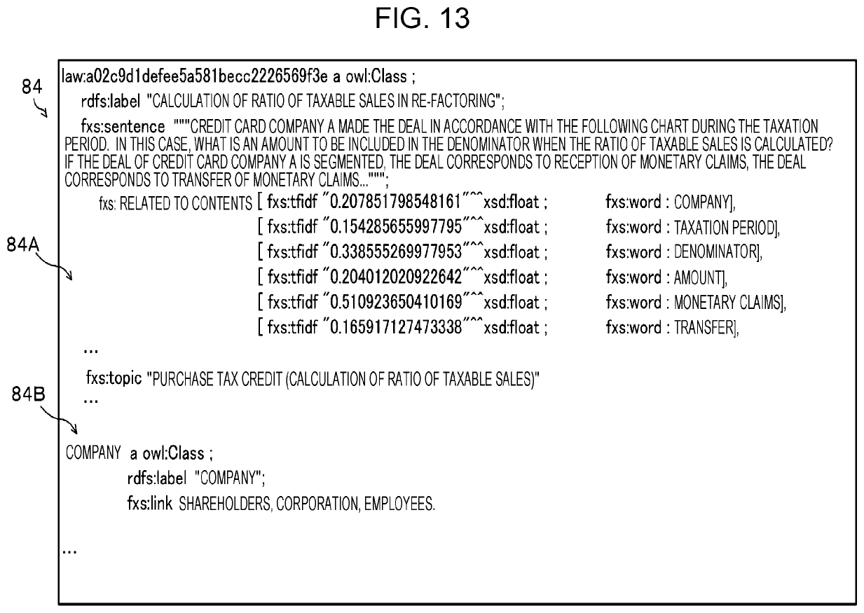

FIG. 13 illustrates the combined knowledge base constructed by the combination unit 44 of the first exemplary embodiment.

Referring to FIG. 13, a block 84 includes as an example of the combined knowledge base pieces of information, such as content nodes and word nodes, described in association with each other. According to the first exemplary embodiment, the combined knowledge base is represented by data in RDF.

In the combined knowledge base in FIG. 13, information “law: . . . owl:Class” is described as a content node 84A. One or more labels are imparted to the content node 84A. “rdfs: label” is imparted to the content node 84A with the label imparted. Referring to FIG. 13, a character string indicating the “title” of the input content is described. “fxs: sentence” is imparted to the content node 84A and a character string indicating a “description” of the input content is described. “fxs: related to contents” is imparted to the content node 84A. The degree of importance with “fxs: tfidf” imparted thereto is imparted to each word of the character string indicating a “description” of the content. Further, “fxs: topic” is imparted to the content node 84A and a character string indicating a “topic” of the input content is described.

The combined knowledge base includes a word node 84B. Referring to FIG. 13, “company a owl:Class” is described and includes information including a word of a second word node linked with a first word node. Specifically, “rdfs:label” is imparted to the word node 84B with the label imparted thereto. Referring to FIG. 13, “company” is described as a word included in the character string of the input content. A label “fxs:link” of the word node serving as a target having the relationship between word nodes is imparted to the word node 84B. Referring to FIG. 13, “shareholders,” “corporation,” and “employees” indicating the values of link destinations are described.

In the combined knowledge base constructed described above, the character string of the content serving as a search target and the degree of importance of the word related to the character string are imparted to the content node. The combined knowledge base includes the word node. In the combined knowledge base, the word of the second word node associated with the first word node of the word indicated by the word node is described. The processing load, such as processing time, involved in constructing the knowledge base may be reduced in comparison with when the knowledge base is manually constructed each time the content as the search target is acquired.

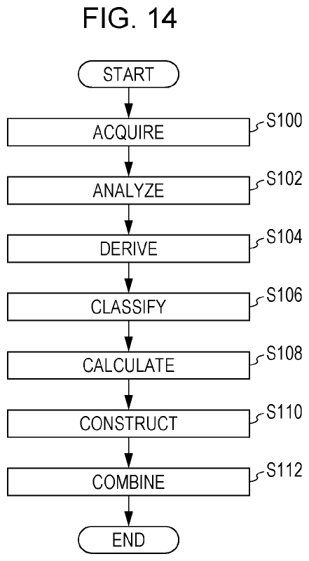

The process of the information processing apparatus 10 of the first exemplary embodiment is described with reference to FIG. 14. FIG. 14 is a flowchart illustrating the process of the information processing program 14A of the first exemplary embodiment.

The information processing apparatus 10 performs the following steps in response to a startup instruction of the information processing program 14A.

In step S100 in FIG. 14, the acquisition unit 32 acquires from the terminal apparatus 50 used by the user the input data illustrated in FIG. 4 or 5 (the document as the search target and the dictionary data in the first exemplary embodiment).

In step S102, the analyzing unit 34 morphologically analyzes the acquired dictionary data and extracts the nouns from the analysis results of the words as illustrated in FIG. 6.

In step S104, the derivation unit 36 derives the community data of the extracted nouns as illustrated in FIG. 7.

As illustrated in FIG. 8, in step S106, the classification unit 38 classifies respectively the nouns into the communities in accordance with the predetermined classification condition by using the community data derived by the derivation unit 36.

In step S108, the arithmetic unit 40 calculates the distances between the words belonging to the same community. Specifically, the arithmetic unit 40 identifies the relationship between the words by calculating the distances between the words.

In step S110, the producing unit 42 constructs the word knowledge base in accordance with the semantic distance calculated by the arithmetic unit 40 as illustrated in FIG. 10. Specifically, the producing unit 42 identifies the relationship of the words at the community in accordance with the predetermined distance condition. The producing unit 42 constructs the word knowledge base in accordance with the identified relationship of the words.

In step S112, the combination unit 44 constructs the combined knowledge base by combining the word knowledge base and the input content as illustrated in FIG. 13. The constructed combined knowledge base is stored on the memory 14. The series of operations of the information processing program 14A are thus complete.

According to the first exemplary embodiment, the word knowledge base based on the semantic distance of the words in the dictionary data is produced from the document serving as the search target and the input data, such as the dictionary data. The combined knowledge base is constructed by combining the word knowledge base and the input content. The resulting knowledge base may thus enable the intention of the user to be reflected in the search results. The knowledge base may thus be constructed in a manner that is free from manual production performed each time the content as the search target is acquired. The processing load, such as processing time, involved in producing the knowledge base may be reduced.

### Second Exemplary Embodiment

A second exemplary embodiment is described below. The second exemplary embodiment is identical in configuration to the first exemplary embodiment. Like elements are designated with like reference numerals and the discussion thereof is omitted.

According to the first exemplary embodiment, the word knowledge base based on the semantic distance is constructed from the document as the search target and the input data, such as the dictionary data. The combined knowledge base is constructed by combining the word knowledge base with the input content.

The user may intentionally add data to, or delete or update a portion of the input data including the content data, such as the document like the search target. In such a case, the processing load used to produce the knowledge base increases if a new knowledge base is constructed each time the input data is partially modified.

The second exemplary embodiment relates an information processing apparatus that may reduce the processing load involved in producing the knowledge base when the user add data to, or delete or update a portion of the input data, such as the document like the search target.

The network system 90 of the second exemplary embodiment including the information processing apparatus 10 and the terminal apparatus 50 is identical in configuration to those of the first exemplary embodiment and the detailed discussion thereof is omitted (see FIGS. 1 through 3).

In the second exemplary embodiment, the user adds data to, or deletes or updates a portion of the input data including the content data, such as the document like the search target. In the second exemplary embodiment as well, the content data input and the word knowledge base constructed in the first exemplary embodiment are stored on the memory 14. The combined knowledge base constructed may also be stored on the memory 14.

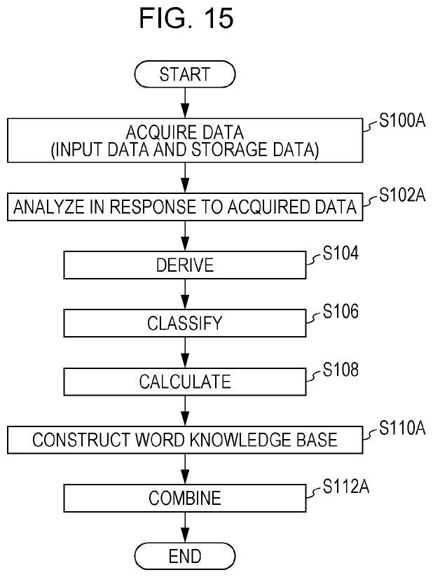

According to the second exemplary embodiment, an information processing program 14X in FIG. 15 may be stored in place of the information processing program 14A on the memory 14.

The process of the information processing apparatus 10 of the second exemplary embodiment is described with reference to FIG. 15.

FIG. 15 is a flowchart illustrating the process of the information processing program 14X of the second exemplary embodiment.

The information processing program 14X in FIG. 15 includes steps S100A, S102A, S110A, and S112A respectively in place of steps S100, S102, S110, and S112 in the information processing program 14A in FIG. 14.

The following steps are performed when the information processing apparatus 10 receives a startup instruction of the information processing program 14X.

In step S100A in FIG. 15, in the same way as in step S100 in FIG. 14, the acquisition unit 32 acquires the input data from the terminal apparatus 50 used by the user. In step S100A of the second exemplary embodiment, the content data in FIG. 4 pre-stored on the memory 14, namely, a target search document prior to the modification (hereinafter referred to as original content data) is acquired. The word knowledge base in FIG. 10 pre-stored on the memory 14, namely, the word knowledge base prior to the modification (hereinafter referred to as an original word knowledge base) is acquired. In step S100A, the dictionary data is also acquired.

The combined knowledge base in FIG. 13 may be pre-stored on the memory 14 and the acquisition unit 32 may retrieve from the memory 14 the combined knowledge base, namely, the combined knowledge base prior to the modification (hereinafter referred to as an original combined knowledge base).

In step S100A, information indicating a modification detail to the original content data is also acquired from the terminal apparatus 50 used by the user. Specifically, information indicating the modification detail indicating at least one of the addition of data to, the deletion of a portion of, and/or the update of a portion of the original content data is acquired. Specifically, if new content data is added to the original content data, the content data to be added (hereinafter referred to as addition content data) is acquired. If the portion of the original content data is to be deleted, data indicating the location and the content of the content data to be deleted (hereinafter referred to as deletion content data) is acquired. If the portion of the original content data is to be updated, data indicating the location and the content of the content data to be updated (hereinafter referred to as update content data) is acquired.

If the dictionary data serving as a target in modifying the original content data increases or decreases, the acquisition unit 32 increases or decreases the target dictionary data and then acquires the increased or decreased target dictionary data.

In step S102A, in the same way as in step S102 in FIG. 14, the analyzing unit 34 morphologically analyzes the acquired dictionary data and extracts the nouns from the analysis results of the words as illustrated in FIG. 6. If the modification detail is the addition of data to the original content data, the analyzing unit 34 extracts the addition content data and the nouns present in the dictionary data in step S102A. If the modification detail is the update of the portion of the original content data, the analyzing unit 34 extracts the update content data and the nouns present in the dictionary data in step S102A.

In step S104 in FIG. 14 as previously described, the derivation unit 36 derives the community data of the extracted nouns (as illustrated in FIG. 7). In step S106, the classification unit 38 classifies respectively the nouns into the communities in accordance with the predetermined classification condition by using the community data (as illustrated in FIG. 8). In step S108, the arithmetic unit 40 calculates the distances between the words belonging to the same community.

In step S110A, in the same way as in step S110 in FIG. 14, the producing unit 42 constructs the word knowledge base in accordance with the semantic distance calculated by the arithmetic unit 40. In step S110A, the word knowledge base is constructed in response to the information indicating the modification detail to the original content data. Specifically, if the modification detail indicates the addition of data to the original content data, the data is added to the original content data without modifying the structure of the original content data.

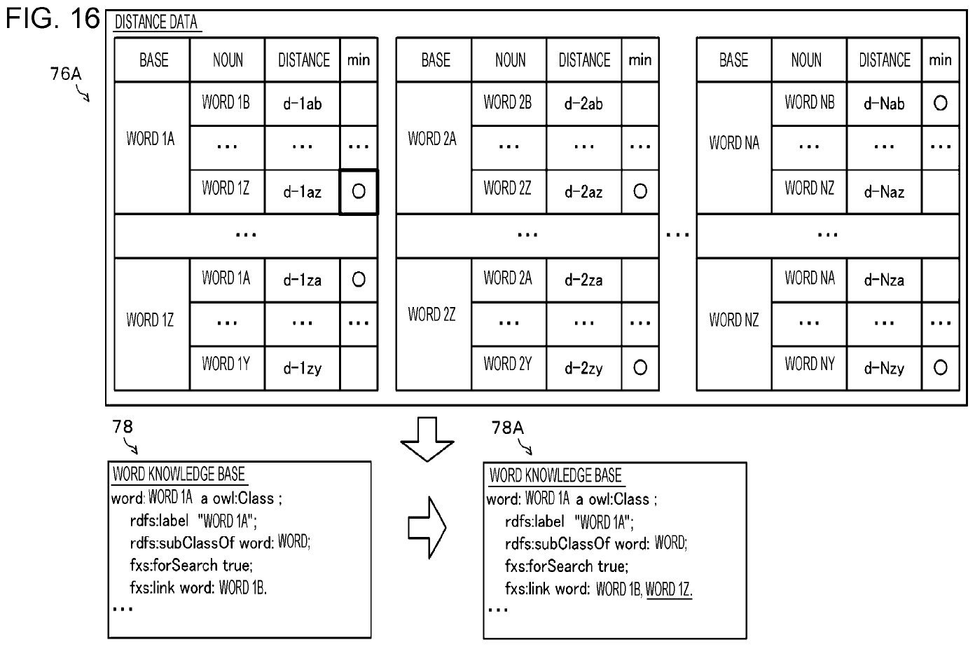

FIG. 16 illustrates the word knowledge base constructed by the producing unit 42 of the second exemplary embodiment.

Referring to FIG. 16, the word knowledge base is constructed if the modification detail indicates the addition of the data to the original content data.

Referring to FIG. 16, a table 76A results if the modification detail is the addition of the data to the original content data. In the table 76A, a word 1Z as a second word having the shortest distance and denoted by a circle (identification information) is imparted to a word 1A as a first word. In the constructed word knowledge base, the block 78 in FIG. 10 is modified to a block 78A. The block 78 includes a description “fxs:link word: word 1B” indicating the relationship between the first word and second word. The block 78 includes a description “fxs:link word: word 1B, word 1Z” with the newly added “word 1Z.” Specifically, if an extracted word is not present in the original word knowledge base, it is added.

If the modification detail indicates the deletion of a portion of the original content data, the portion of the original content data is deleted without modifying the structure of the original word knowledge base.

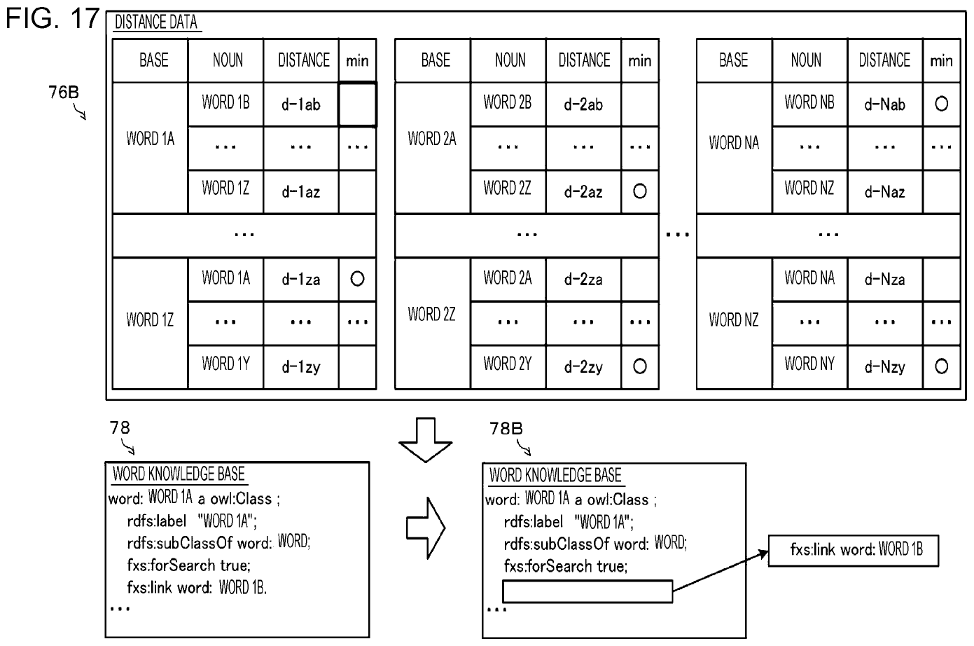

FIG. 17 illustrates an example of the word knowledge base constructed by the producing unit 42 of the second exemplary embodiment.

The word knowledge base in FIG. 17 is constructed if the modification detail indicates the deletion of the portion of the original content data.

FIG. 17 illustrates a table 76B when the modification detail indicates the deletion of a portion of the original content data. In the table 76B, in response to the deletion of the portion of the original content data, the circle (identification information) is cancelled on the word 1B as the second word having the shortest distance to the word 1A as the first word. In the constructed word knowledge base, the block 78 in FIG. 10 is modified to a block 78B. The block 78 includes a description “fxs:link word: word 1B” indicating the relationship between the first word and the second word. The block 78B includes a description with the relationship deleted. Specifically, a word having a minimum distance is extracted from words present in the deletion content data and if that word is present in the original word knowledge base, that word is deleted.

If the modification detail indicates the update of a portion of the original content data, the portion is updated without modifying the structure of the original word knowledge base.

If the modification detail indicates the update of the portion of the original content data, the deletion operation and addition operation described above may be successively performed. Specifically, for the portion to be updated, the word knowledge base is constructed in accordance with the method applied to delete the portion as illustrated in FIG. 17. The word knowledge base is further modified in accordance with the method applied to add the portion as illustrated in FIG. 16. The portion of the data is thus updated without modifying the structure of the original word knowledge base.

In step S112A, in the same way as in step S112 in FIG. 14, the combination unit 44 constructs the combined knowledge base by combining the word knowledge base with the input content (see FIG. 13). In step S112A, the combined knowledge base is constructed by associating the content node with the word node in response to the modification detail to the original content data.

Specifically, if the modification detail indicates the addition of data to the original content data, the data is added without modifying the structure of an original combined knowledge base. In other words, degrees of importance are imparted to nouns present in the word knowledge base and in the original content data and addition content data and the resulting data is linked. The combined knowledge base is thus constructed.

If the modification detail indicates the deletion of a portion of the original content data, the portion is deleted without modifying the structure of an original combined knowledge base. Specifically, the deletion content data is deleted from the original content data, and degrees of importance are imparted to nouns present in the word knowledge base and the resulting data is linked. The combined knowledge base is thus constructed.

If the modification detail indicates the update of a portion of the original content data, the portion is updated without modifying the structure of an original combined knowledge base. Specifically, degrees of importance are imparted to nouns present in the word knowledge base and in the update data of the original content data and the resulting data is linked. The combined knowledge base is thus constructed.

According to the second exemplary embodiment, even when the portion of the content data, such as a document as a search document, is modified through the addition, deletion, or update, only modifying a portion of the knowledge base is involved. Processing load in producing the knowledge base may thus be controlled.

The modification of the word knowledge base and the combined knowledge base in accordance with the second exemplary embodiment has been described. The disclosure is not limited to the above description. For example, one of the word knowledge base and the combined knowledge base may be modified.

The information processing apparatus of the exemplary embodiments has been described. The exemplary embodiments may be construed as a program that causes a computer to operate as the elements in the information processing apparatus. The exemplary embodiments may be also construed as a computer readable storage medium having stored the program.

The configuration of the information processing apparatus of the exemplary embodiments have been described for exemplary purposes only and may be modified without departing from the scope of the disclosure.

The processes of the program described above have been described for exemplary purposes only. For example, a step may be added to or deleted from the processes, or the order of steps may be changed without departing from the scope of the disclosure.

According to the exemplary embodiments, the processes of the exemplary embodiments are implemented via a software configuration that a computer performs by executing the program. The disclosure is not limited to this method. For example, the exemplary embodiments may be implemented by using a hardware configuration, software configuration, or a combination thereof.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to:
acquire a content serving as a search target and character string data related to the content,
extract a plurality of words from the character string data in accordance with results of morphological analysis performed on the acquired character string data,
construct a word knowledge base that associates a word of interest of the extracted words with information indicating a nodal relationship between the word of interest of the extracted words serving as a node and each remaining word of the extracted words serving as a node and having a semantic distance shorter than a predetermined distance, and
construct a combined knowledge base that associates with the information indicating the nodal relationship a degree of importance of each of the words present on the word knowledge base from among the words in the content.

2. The information processing apparatus according to claim 1, wherein the processor is configured to extract a word indicating a noun from among the results of the morphological analysis as a word in the character string data.

3. The information processing apparatus according to claim 1, wherein the processor is configured to calculate the degree of importance through a term frequency-inverse document frequency (TF-IDF) method.

4. The information processing apparatus according to claim 2, wherein the processor is configured to calculate the degree of importance through a term frequency-inverse document frequency (TF-IDF) method.

5. The information processing apparatus according to claim 1, wherein the processor is configured to:
store the content and the word knowledge base on a memory, and
in response to a modification to the content, correct at least one of the word knowledge base and/or the combined knowledge base.

6. The information processing apparatus according to claim 2, wherein the processor is configured to:
store the content and the word knowledge base on a memory, and
in response to a modification to the content, correct at least one of the word knowledge base and/or the combined knowledge base.

7. The information processing apparatus according to claim 3, wherein the processor is configured to:
store the content and the word knowledge base on a memory, and
in response to a modification to the content, correct at least one of the word knowledge base and/or the combined knowledge base.

8. The information processing apparatus according to claim 4, wherein the processor is configured to:
store the content and the word knowledge base on a memory, and
in response to a modification to the content, correct at least one of the word knowledge base and/or the combined knowledge base.

9. The information processing apparatus according to claim 5, wherein the modification to the content comprises at least one of an information addition to the content, an information update of the content and/or an information deletion of the content.

10. The information processing apparatus according to claim 6, wherein the modification to the content comprises at least one of an information addition to the content, an information update of the content and/or an information deletion of the content.

11. The information processing apparatus according to claim 7, wherein the modification to the content comprises at least one of an information addition to the content, an information update of the content and/or an information deletion of the content.

12. The information processing apparatus according to claim 8, wherein the modification to the content comprises at least one of an information addition to the content, an information update of the content and/or an information deletion of the content.

13. The information processing apparatus according to claim 9, wherein the processor is configured to, in accordance with a difference between the content before the modification and the content after the modification, correct a portion of at least one of the word knowledge base and/or the combined knowledge base corresponding to a location of the modification.

14. The information processing apparatus according to claim 10, wherein the processor is configured to, in accordance with a difference between the content before the modification and the content after the modification, correct a portion of at least one of the word knowledge base and/or the combined knowledge base corresponding to a location of the modification.

15. The information processing apparatus according to claim 11, wherein the processor is configured to, in accordance with a difference between the content before the modification and the content after the modification, correct a portion of at least one of the word knowledge base and/or the combined knowledge base corresponding to a location of the modification.

16. The information processing apparatus according to claim 12, wherein the processor is configured to, in accordance with a difference between the content before the modification and the content after the modification, correct a portion of at least one of the word knowledge base and/or the combined knowledge base corresponding to a location of the modification.

17. The information processing apparatus according to claim 13, wherein the modification of the portion of at least one of the word knowledge base and/or the combined knowledge base is performed by modifying information indicating the nodal relationship between nodes of at least one of the word knowledge base and/or the combined knowledge base corresponding to the location of the modification.

18. The information processing apparatus according to claim 14, wherein the modification of the portion of at least one of the word knowledge base and/or the combined knowledge base is performed by modifying information indicating the nodal relationship between nodes of at least one of the word knowledge base and/or the combined knowledge base corresponding to the location of the modification.

19. The information processing apparatus according to claim 15, wherein the modification of the portion of at least one of the word knowledge base and/or the combined knowledge base is performed by modifying information indicating the nodal relationship between nodes of at least one of the word knowledge base and/or the combined knowledge base corresponding to the location of the modification.

20. A non-transitory computer readable medium storing a program causing a computer to execute a process for processing information, the process comprising:
acquiring a content serving as a search target and character string data related to the content;
extracting a plurality of words from the character string data in accordance with results of morphological analysis performed on the acquired character string data;
constructing a word knowledge base that associates a word of interest of the extracted words with information indicating a nodal relationship between the word of interest of the extracted words serving as a node and each remaining word of the extracted words serving as a node and having a semantic distance shorter than a predetermined distance; and
constructing a combined knowledge base that associates with the information indicating the nodal relationship a degree of importance of each of the words present on the word knowledge base from among the words in the content.
